(19) United States
(12) Patent Application Publication
(10) Pub. No.: US 2024/0237155 A1
(43) Pub. Date: Jul. 11, 2024

(54) ELECTRIC HEATING DEVICE

(71) Applicant: KANKEN TECHNO CO.,LTD., Kyoto (JP)

(72) Inventors: Takeshi HANAFUSA, Kyoto (JP); Tomoki SUZUKI, Kyoto (JP); Hideharu OHMAE, Kyoto (JP); Hiroshi IMAMURA, Kyoto (JP)

(21) Appl. No.: 18/000,890

(22) PCT Filed: Jun. 18, 2020
(86) PCT No.: PCT/JP2020/023962

§ 371 Date: Dec. 6, 2022

(51) Int. Cl. H05B 3/64; H05B 3/16

(52) U.S. Cl. CPC H05B 3/64; H05B 3/16

(57) ABSTRACT

An electric heating device includes: a radiant tube made of metal; a plurality of heater wires disposed in the radiant tube so as to be parallel to each other; a heater fixing shaft disposed on a center axis line of the radiant tube, the heater fixing shaft having a surface covered by an insulator; and disk-shaped ceramic insulators mounted to the heater fixing shaft at predetermined intervals so as to support the heater wires. A center hole in which the heater fixing shaft is inserted penetrates through each ceramic insulator at a center thereof, and heater wire holding holes that are equally spaced on a circumference concentric with the center hole penetrate through each ceramic insulator.

### TECHNICAL FIELD

The present invention relates to an electric heating device used in an industrial electric furnace, and particularly relates to a radiant tube heater in which a heat source is stored in a radiant tube.

### BACKGROUND ART

To date, an electric heating device disclosed in Patent Literature 1 (Japanese Patent No. 5270688) has been known as this type of the electric heating device. This conventional art is configured as follows.

The electric heating device includes a radiant tube and a heating element disposed in the radiant tube, and the heating element is formed by a heating wire and is connected to a current outlet at one end of the radiant tube. The heating element is supported in the radiant tube with the help of a support. A protective insert made of a conductive material is disposed between the radiant tube and the heating element.

In the conventional art, since the protective insert is disposed between the radiant tube and the heating element, melted metal and heating element remainder which may be caused by element failure fall onto the protective insert due to gravitational force. Therefore, it is said that unnecessary damage to the radiant tube can be prevented to minimize damage to the electric heating device due to the element failure.

### CITATION LIST

### Patent Literature

[PTL 1] Japanese Patent No. 5270688

### SUMMARY OF INVENTION

### Technical Problem

However, the above-described conventional art has the following problem.

That is, in order to cause the melted metal and the heating element remainder which may be caused by element failure to fall onto the protective insert due to gravitational force, the electric heating device needs to be horizontally mounted in an electric furnace, so that an arrangement structure for the electric heating device and the usage thereof are restricted.

Furthermore, the conventional art has a significant problem that the element failure itself such as electric leakage from the heating element is not prevented.

Therefore, a main object of the present invention is to provide an electric heating device that can be stably operated for a long time period by reducing element failure that may cause various troubles.

### Solution to Problem

In order to attain the above-described object, an electric heating device of the present invention has a configuration described below as illustrated in FIG. 1 to FIG. 2.

That is, the electric heating device includes: a radiant tube 12 made of metal; a plurality of heater wires 14 disposed in the radiant tube 12 so as to be parallel to each other; a heater fixing shaft 16 disposed on a center axis line of the radiant tube 12, the heater fixing shaft 16 having a surface covered by an insulator; and disk-shaped ceramic insulators 18 mounted to the heater fixing shaft 16 at predetermined intervals so as to support the heater wires 14. A center hole 20 in which the heater fixing shaft 16 is inserted penetrates through each ceramic insulator 18 at a center thereof, and heater wire holding holes 22 that are equally spaced on a circumference concentric with the center hole 20 penetrate through each ceramic insulator 18. An outer diameter of each ceramic insulator 18 or a diameter of a circumscribed circle of the ceramic insulator 18 is less than an inner diameter of the radiant tube 12 or a diameter of an inscribed circle of the radiant tube 12 as viewed in an axial direction of the radiant tube 12 in a normal state.

The inventors of the present invention have found that, in this type of electric heating device, that is, in an electric heating device in which an insulator such as a heater fixing shaft and a ceramic insulator, and a heater wire are stored in a radiant tube made of metal and protected from an external atmosphere, when the electric heating device is operated to generate heat, or stopped and cooled, the inner surface of the radiant tube and (mainly) the circumferential edge of the ceramic insulator come into contact with each other and slide due to the members having different coefficients of thermal expansion, metal oxide generated on the inner surface of the radiant tube is chipped and accumulated around the heater wire on the ceramic insulator, increase of an amount of the accumulated metal oxide causes shortcircuiting between the adjacent heater wires, and this is a major cause of element failure.

Therefore, in the electric heating device of the present invention, the outer diameter of the ceramic insulator 18 or the diameter of the circumscribed circle of the ceramic insulator 18 is made less than the inner diameter of the radiant tube 12 or the diameter of the inscribed circle of the radiant tube 12 as viewed in the axial direction of the radiant tube 12 in a normal state. Accordingly, when the electric heating device is operated to generate heat, or stopped and cooled, contact between the inner surface of the radiant tube 12 and the circumferential edge portion of the ceramic insulator 18 can be minimized, and a chipped amount of metal oxide due to the contact therebetween can be substantially reduced.

In the present invention, at least a portion, of a circumferential edge portion of each ceramic insulator 18, which comes into contact with the radiant tube 12 is preferably formed in a round shape.

In this case, even if the inner surface of the radiant tube 12 and the circumferential edge portion of the ceramic insulator 18 come in contact with each other, a chipped amount of metal oxide due to the contact therebetween can be further reduced.

In the present invention, as illustrated in FIG. 3 and FIG. 4, each ceramic insulator 18 is preferably formed in a rotation-symmetrical polygonal shape in a planar view.

In this case, even if the inner surface of the radiant tube 12 and the circumferential edge portion of the ceramic insulator 18 come in contact with each other, a gap can be constantly formed therebetween, and metal oxide chipped from the inner surface of the radiant tube 12 can be discharged downward through the gap, and can be inhibited from being accumulated on the ceramic insulator 18.

In the present invention, as illustrated in FIG. 5, each ceramic insulator 18 preferably has, in an upper surface, a recessed groove 30 positioned between the heater wire holding holes 22 adjacent to each other in an outer circumferential direction of the center hole 20.

In this case, metal oxide that is chipped and separated/dropped from the inner surface of the radiant tube 12 and accumulated on the ceramic insulator 18 is stored in the recessed groove 30. Therefore, shortcircuiting between the adjacent heater wires 14 due to the metal oxide can be substantially retarded.

Furthermore, in the present invention, as illustrated in FIG. 6, a stepped portion 32 that is almost vertically raised is preferably formed by increasing a thickness around the center hole 20 of each ceramic insulator 18.

In this case, metal oxide chipped and separated/dropped from the inner surface of the radiant tube 12 is accumulated on/under the stepped portion 32, and shortcircuiting between the adjacent heater wires 14 due to the metal oxide can be substantially retarded similarly to the above-described recessed groove 30.

In the present invention, as illustrated in FIG. 7 and FIG. 8, preferably, each ceramic insulator 18 is voided between the heater wire holding holes 22 adjacent to each other in an outer circumferential direction of the center hole 20, and one of the heater wires 14 adjacent to each other is disposed at a voided portion.

In this case, the adjacent heater wires 14 are supported by different ceramic insulators 18, respectively, and shortcircuiting between the adjacent heater wires 14 due to metal oxide accumulated on the ceramic insulators 18 can be almost perfectly prevented.

### BRIEF DESCRIPTION OF DRAWINGS

FIG. 1 is an explanatory diagram schematically illustrating an electric heating device according to one embodiment of the present invention (vertical cross-sectional view in which a part of an internal structure is omitted).

FIG. 2 is an end view taken along a line A-A′ in FIG. 1.

FIG. 3 is an end view of an outline of an electric heating device according to another embodiment (second embodiment) of the present invention as taken in the horizontal direction.

FIG. 4 is an end view of an outline of an electric heating device according to another embodiment (third embodiment) of the present invention as taken in the horizontal direction

FIG. 5A is a plan view of a ceramic insulator according to another embodiment (fourth embodiment) of the present invention. FIG. 5B is an end view taken along a line B-B′ in FIG. 5A.

FIG. 6A is a plan view of a ceramic insulator according to another embodiment (fifth embodiment) of the present invention. FIG. 6B is a cross-sectional view taken along a line D-D′ in FIG. 6A.

FIG. 7A is a plan view of an arranged state of ceramic insulators according to another embodiment (sixth embodiment) of the present invention. FIG. 7B is a cross-sectional view (partially omitted) taken along a line E-E′ in FIG. 7A.

FIG. 8A is a plan view of an arranged state of ceramic insulators according to another embodiment (seventh embodiment) of the present invention. FIG. 8B is a cross-sectional view (partially omitted) taken along a line F-F′ in FIG. 8A.

### DESCRIPTION OF EMBODIMENTS

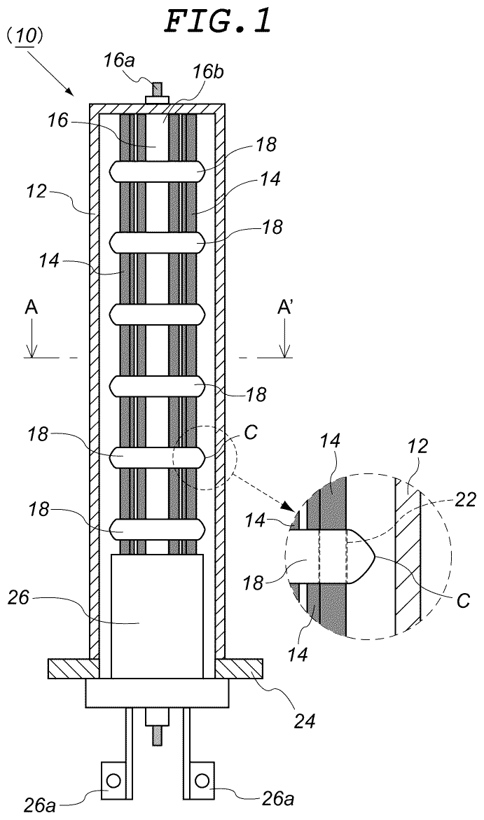

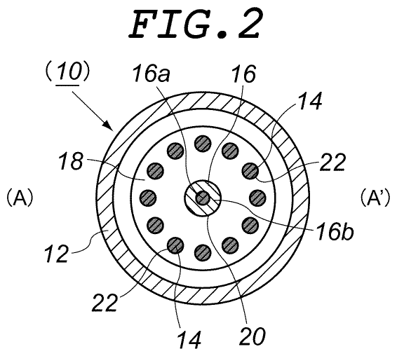

One embodiment of the present invention will be described below with reference to FIG. 1 and FIG. 2.

FIG. 1 is a vertical cross-sectional view of an electric heating device 10 of the present embodiment in a state where a part (specifically, heater wires 14 disposed on the front surface side, and the like) of an internal structure is omitted. The electric heating device 10 of the present embodiment is a device that is used as a heat source of an industrial electric furnace used in various industrial processes. As illustrated in FIG. 1, the electric heating device 10 mainly includes a radiant tube 12, a heater wire 14, a heater fixing shaft 16, and a ceramic insulator 18.

The radiant tube 12 is a metal tube in which one end in the longitudinal direction is closed and the other end in the longitudinal direction is opened, and a heating unit such as the heater wire 14 is thus stored. The radiant tube 12 protects the heating unit from an external atmosphere (=environment in a furnace), and dissipates heat generated by the heater wire 14 to the outside (in the furnace).

A metal material of the radiant tube 12 is selected as appropriate according to an environment in which the electric heating device 10 is used. For example, in a case where highly corrosive gas exists in the external environment of the radiant tube 12, a metal material such as HASTELLOY (HAYNES registered trademark; the same applies to the following) C22 having high corrosion resistance is preferably used.

A flange 24 is disposed on the open end side at the other end of the radiant tube 12 in the longitudinal direction, and the electric heating device 10 is mounted to, for example, a furnace wall (not illustrated) of the electric furnace via the flange 24.

In the illustrated embodiment, the radiant tube 12 is formed as a round cylindrical body. However, the radiant tube 12 is not limited to such a form, and may be, for example, formed as a polygonal tubular body as necessary.

The heater wire 14 is an elongated heating resistor which is formed as a metal wire such as a nichrome wire or a KANTHAL (Sandvik registered trademark) wire or obtained by forming, for example, a heating element such as SiC into a bar-shaped member, and allows electric current to flow therethrough to increase a temperature to about 800° C. to 1400° C. according to a kind of the material or the like. As illustrated in FIG. 2, in the present embodiment, twelve heater wires 14 are equally spaced from each other around the axis of the heater fixing shaft 16 described below; and are electrically connected in series via a heater plate (not illustrated) formed of a material such as Ni (nickel) having excellent conductivity and corrosion resistance. A plug 26 is mounted to one end (lower end in the embodiment in FIG. 1) of the heater wire 14 in the longitudinal direction, and a wire from a not-illustrated power supply is connected to a terminal 26a of the plug 26.

In a case where the heater wire 14 is formed as a metal wire, the heater wire 14 may have a straight single wire shape (bar-like shape) as in the illustrated embodiment, or may be formed by helically winding the metal wire.

The heater fixing shaft 16 is an elongated member for supporting the heater wire 14 via the ceramic insulator 18 described below; and includes a core member 16a formed as a stainless-steel round rod, and an insulating covering tube 16b that is made of ceramic and that functions as an insulator that covers the surface of the core member 16a.

The heater fixing shaft 16 is disposed on the center axis line of the radiant tube 12, and a plurality of the ceramic insulators 18 described below are mounted to the heater fixing shaft 16 at predetermined intervals.

The ceramic insulator 18 is a disk-shaped instrument for insulating and fixing the heater wire 14 at a predetermined position in the radiant tube 12 in conjunction with the heater fixing shaft 16. In the present embodiment, as illustrated in FIG. 2, the ceramic insulator 18 is formed in a perfect circular shape in a planar view; and, as illustrated in FIG. 1, the shape of the circumferential edge has the maximal outer diameter at the center “C” in the thickness direction, and the outer diameter is gradually reduced toward both the front and back surfaces. That is, the entirety of the circumferential surface is formed in a round shape.

In the ceramic insulator 18, a center hole 20 in which the heater fixing shaft 16 is inserted is formed at the center of the ceramic insulator 18, and twelve heater wire holding holes 22 are formed so as to be equally spaced on the circumference that is concentric with the center hole 20.

It is notable that the outer diameter of the ceramic insulator 18 is set to be less than the inner diameter of the radiant tube 12 as viewed in the axial direction of the radiant tube 12, and both the ceramic insulator 18 and the radiant tube 12 have sizes so as not to come into contact with each other in a normal temperature state (that is, normal state) in which the heater wire 14 is not operated.

In the electric heating device 10 of the present embodiment having the above-described structure, even if the members have different coefficients of thermal expansion, when the heater wire 14 is electrically energized to generate heat, or when the electrical energization of the heater wire 14 is stopped to cool the heater wire 14, the inner surface of the radiant tube 12 and the circumferential edge of the ceramic insulator 18 are prevented from coming into contact with each other and sliding, and metal oxide generated on the inner surface of the radiant tube 12 can be inhibited from being chipped. Furthermore, since the entirety of the circumferential surface of the ceramic insulator 18 is formed in a round shape, even if the inner surface of the radiant tube 12 and (mainly) the circumferential edge of the ceramic insulator 18 come into contact with each other and slide to chip metal oxide generated on the inner surface of the radiant tube 12, stress applied to the inner surface of the radiant tube 12 by the circumferential edge portion of the ceramic insulator 18 is reduced to substantially reduce a chipped amount of the metal oxide when the inner surface of the radiant tube 12 and the circumferential edge portion of the ceramic insulator 18 come into contact with each other. Therefore, generation of element failure that may cause various troubles can be maximally retarded, and operation can be stably performed for a long time period.

In the above-described embodiment, the heater wire 14 and the heater fixing shaft 16 which are round-rod-shaped are used. However, the shapes of the heater wire 14 and the heater fixing shaft 16 are not limited to such a shape, and may be, for example, quadrangular-bar-like shapes. In such a case, the shapes of the center hole 20 and the heater wire holding hole 22 of the ceramic insulator 18 are not perfect circular shapes, but shapes along the outer shapes of the quadrangular-bar-shaped heater fixing shaft 16 and heater wire 14.

In the above-described embodiment, six ceramic insulators 18 are mounted to the heater fixing shaft 16 in the radiant tube 12. However, the number of the ceramic insulators 18 mounted to the heater fixing shaft 16 is not limited to six. The number of the ceramic insulators 18 may be, for example, less than or equal to 5 or greater than or equal to 7. However, the number of the ceramic insulators 18 needs to be determined such that thermal efficiency of the electric heating device 10 is not hindered due to absorption of heat from generated heat by the heater wire 14.

In the above-described embodiment, twelve heater wires 14 are disposed in the radiant tube 12 (see FIG. 2). The number of the heater wires 14 disposed in the radiant tube 12 is not limited to twelve, and may be increased or reduced as appropriate when necessary.

In the above-described embodiment, the radiant tube 12 is formed as a round cylindrical body, and the ceramic insulator 18 is formed in a perfect circular shape in a planar view. However, the radiant tube 12 may be formed as a polygonal tubular body, and the ceramic insulator 18 may be formed in a polygonal shape in a planar view as described below. Alternatively, the ceramic insulator 18 may be formed in an ellipsoidal shape in a planar view. Also in these cases, as viewed in the axial direction of the radiant tube 12, the diameter of the circumscribed circle of the ceramic insulator 18 is made less than the diameter of the inscribed circle of the radiant tube 12 in the normal state.

In the above-described embodiment, as illustrated in FIG. 1, the flange 24 and the plug 26 are disposed on the lower side of the radiant tube 12, and the electric heating device 10 is erected in a not-illustrated electric furnace. However, a state in which the electric heating device 10 of the present invention is set in the electric furnace is not limited thereto. For example, the electric heating device 10 may be disposed such that the flange 24 and the plug 26 are disposed on the upper side of the radiant tube 12 in the vertically opposite arrangement to that in FIG. 1, and the electric heating device 10 is vertically disposed in a not-illustrated electric furnace. Power may be supplied to the electric heating device 10 via the plug 26 such that the plugs 26 are disposed at both ends of the radiant tube 12 in the longitudinal direction, and power is supplied from both sides of the radiant tube 12 in the longitudinal direction. Furthermore, although, in the embodiment in FIG. 1, the end (upper end) of the heater wire 14 is structured to reach the ceiling surface of the radiant tube 12, a space may be formed between the end (upper end) of the heater wire 14 and the ceiling surface of the radiant tube 12. This also applies to the case where the electric heating device 10 has the vertically opposite arrangement as described above.

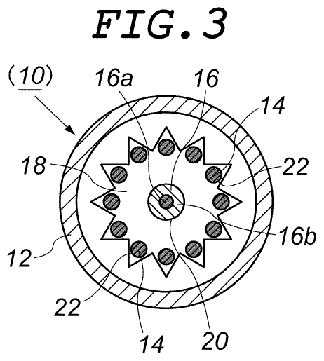

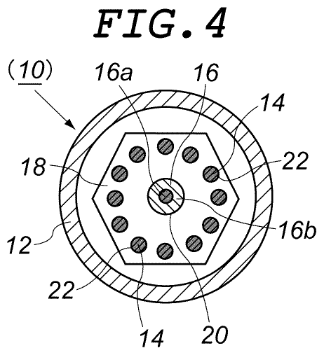

In the above-described embodiment, the ceramic insulator 18 formed in a perfect circular shape in a planar view is used. However, the ceramic insulator 18 more preferably has a rotation-symmetrical polygonal shape in a planar view such as a rotation-symmetrical star-like polygonal shape in a planar view as illustrated in FIG. 3, or a regular hexagonal shape in a planar view as illustrated in FIG. 4. Alternatively, as described above, the ceramic insulator 18 may be formed in an ellipsoidal shape in a planar view. Also in these cases, the shape of the circumferential edge of the ceramic insulator 18 is preferably formed such that the entirety of the circumferential surface or a part, of circumferential surface, which comes into contact with the inner surface of the radiant tube 12 is formed in a round shape.

In such configurations, even in a case where the inner surface of the radiant tube 12 and the circumferential edge portion of the ceramic insulator 18 come into contact with each other due to heat generation by the heater wire 14, a gap can be formed therebetween, and metal oxide chipped from the inner surface of the radiant tube 12 is discharged downward through the gap, and can be further inhibited from being accumulated on the ceramic insulator 18.

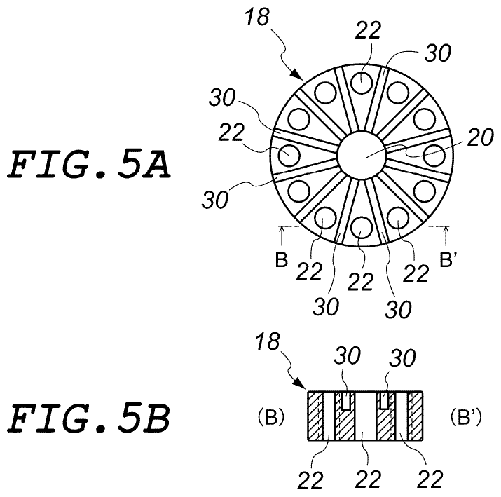

In the above-described embodiment, the surface (upper surface) of the ceramic insulator 18 is formed to be a plane. However, for example, as illustrated in FIG. 5, recessed grooves 30 are preferably each positioned between the heater wire holding holes 22 adjacent to each other in the outer circumferential direction of the center hole 20 in the upper surface of the ceramic insulator 18.

Generation of metal oxide due to rubbing between the ceramic insulator 18 and the inner surface of the radiant tube 12 can be addressed by the above-described technique. However, generation of powder may be caused by oxidation of metal surface due to high temperature as well as the rubbing, and the powder of the metal oxide may be separated/dropped from the surface of the radiant tube 12 and accumulated on the surface of the ceramic insulator 18. Also in such a case, shortcircuiting between the adjacent heater wires 14 may be caused due to the metal oxide accumulated on the ceramic insulator 18 to cause electric leakage.

However, in a case where, as in the present embodiment, the recessed groove 30 is positioned between the heater wire holding holes 22 adjacent to each other in the outer circumferential direction of the center hole 20 in the upper surface of the ceramic insulator 18, shortcircuiting between the adjacent heater wires 14 due to powder of the metal oxide can be substantially retarded.

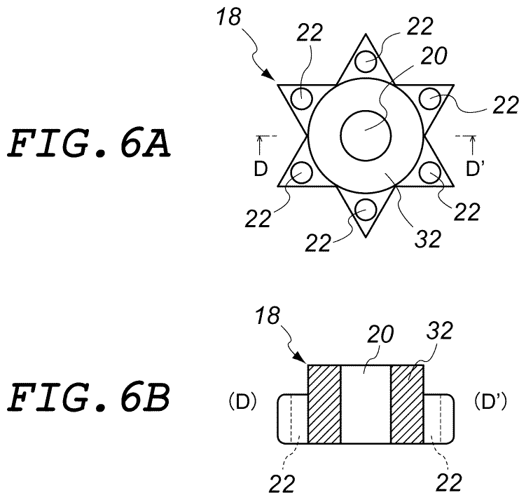

Furthermore, instead of the recessed groove 30 or by using the recessed groove 30 in combination, as illustrated in FIG. 6, a stepped portion 32 that is almost vertically raised is preferably formed by increasing the thickness around the center hole 20 of the ceramic insulator 18. In this case, metal powder is not accumulated on the surface of the raised portion that is almost vertically raised. Therefore, even if metal oxide is chipped and separated/dropped from the inner surface of the radiant tube 12 and accumulated on/under the stepped portion 32, shortcircuiting between the adjacent heater wires 14 due to the metal oxide can be substantially retarded similarly to the above-described recessed groove 30.

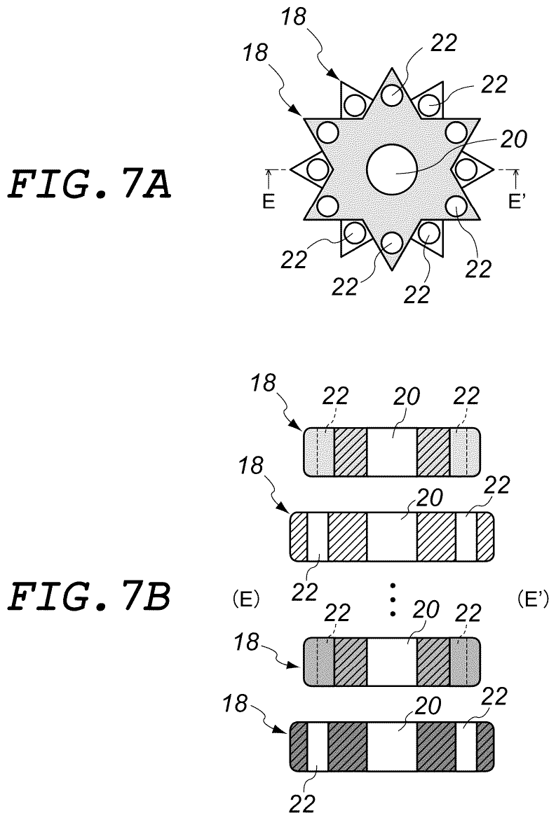

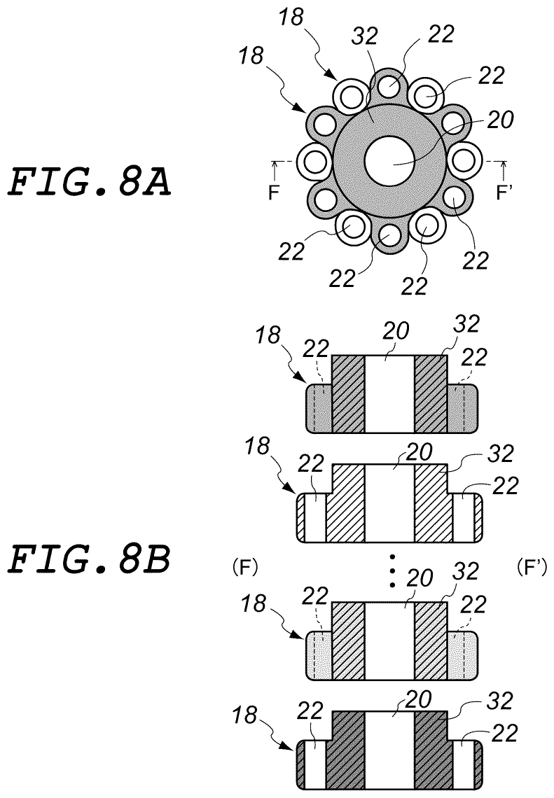

In the above-described embodiment illustrated in FIG. 1, all of the plurality (twelve) of the heater wires 14 disposed so as to be parallel to each other are held by each ceramic insulator 18 at the heater wire holding holes 22, respectively. However, for example, as illustrated in FIG. 7 and FIG. 8, it is preferable that the ceramic insulator 18 is voided between the heater wire holding holes 22 adjacent to each other in the outer circumferential direction of the center hole 20 of the ceramic insulator 18, and one of the adjacent heater wires 14 is disposed at the voided portion. In such a configuration, the adjacent heater wires 14 are supported by different ceramic insulators 18, respectively, and shortcircuiting between the adjacent heater wires 14 due to metal oxide accumulated on the ceramic insulators 18 can be almost perfectly prevented.

In the examples illustrated in FIG. 7 and FIG. 8, the rotation-symmetrical ceramic insulator 18 having the six heater wire holding holes 22 is used, and the ceramic insulators 18 disposed in the up-down direction are rotated by 30° relative to each other, whereby the twelve heater wires 14 are held. However, the present embodiment is not limited to the illustrated configurations, and may have any configuration as long as the ceramic insulator 18 is voided between the heater wire holding holes 22 adjacent to each other in the outer circumferential direction of the center hole 20 of the ceramic insulator 18, and one of the adjacent heater wires 14 is disposed at the voided portion.

It is needless to say that the present invention can be modified in various other ways within the scope conceived by persons skilled in the art.

### REFERENCE SIGNS LIST

10 electric heating device
12 radiant tube
14 heater wire
16 heater fixing shaft
18 ceramic insulator
20 center hole
22 heater wire holding hole
30 recessed groove
32 stepped portion

1. An electric heating device comprising:
a radiant tube made of metal;
a plurality of heater wires disposed in the radiant tube so as to be parallel to each other;
a heater fixing shaft disposed on a center axis line of the radiant tube, the heater fixing shaft having a surface covered by an insulator; and
disk-shaped ceramic insulators mounted to the heater fixing shaft at predetermined intervals so as to support the heater wires, wherein
a center hole in which the heater fixing shaft is inserted penetrates through each ceramic insulator at a center thereof, and heater wire holding holes that are equally spaced on a circumference concentric with the center hole penetrate through each ceramic insulator,
an outer diameter of each ceramic insulator or a diameter of a circumscribed circle of the ceramic insulator is less than an inner diameter of the radiant tube or a diameter of an inscribed circle of the radiant tube as viewed in an axial direction of the radiant tube in a normal state, and
each ceramic insulator has, in an upper surface, a recessed groove positioned between the heater wire holding holes adjacent to each other in an outer circumferential direction of the center hole.

2. An electric heating device comprising:
a radiant tube made of metal;
a plurality of heater wires disposed in the radiant tube so as to be parallel to each other;
a heater fixing shaft disposed on a center axis line of the radiant tube, the heater fixing shaft having a surface covered by an insulator; and
disk-shaped ceramic insulators mounted to the heater fixing shaft at predetermined intervals so as to support the heater wires, wherein
a center hole in which the heater fixing shaft is inserted penetrates through each ceramic insulator at a center thereof, and heater wire holding holes that are equally spaced on a circumference concentric with the center hole penetrate through each ceramic insulator,
an outer diameter of each ceramic insulator or a diameter of a circumscribed circle of the ceramic insulator is less than an inner diameter of the radiant tube or a diameter of an inscribed circle of the radiant tube as viewed in an axial direction of the radiant tube in a normal state; and
each ceramic insulator has a stepped portion that is almost vertically raised by increasing a thickness around the center hole.

3. An electric heating device comprising:
a radiant tube made of metal;
a plurality of heater wires disposed in the radiant tube so as to be parallel to each other;
a heater fixing shaft disposed on a center axis line of the radiant tube, the heater fixing shaft having a surface covered by an insulator; and
disk-shaped ceramic insulators mounted to the heater fixing shaft at predetermined intervals so as to support the heater wires, wherein
a center hole in which the heater fixing shaft is inserted penetrates through each ceramic insulator at a center thereof, and heater wire holding holes that are equally spaced on a circumference concentric with the center hole penetrate through each ceramic insulator,
an outer diameter of each ceramic insulator or a diameter of a circumscribed circle of the ceramic insulator is less than an inner diameter of the radiant tube or a diameter of an inscribed circle of the radiant tube as viewed in an axial direction of the radiant tube in a normal state, and
each ceramic insulator is voided between the heater wire holding holes adjacent to each other in an outer circumferential direction of the center hole, and one of the heater wires adjacent to each other is disposed at a voided portion.

4. The electric heating device according to claim 1, wherein at least a portion, of a circumferential edge portion of each ceramic insulator, which comes into contact with the radiant tube is formed in a round shape.

5. The electric heating device according to claim 1, wherein each ceramic insulator is formed in a rotation-symmetrical polygonal shape in a planar view.

6. (canceled)
